(19) United States
(12) Patent Application Publication
(10) Pub. No.: US 2026/0148014 A1
(43) Pub. Date: May 28, 2026

(54) FUSING HYBRID-HEAD ARCHITECTURE MODEL FOR LANGUAGE MODELS

(71) Applicant: NVIDIA Corporation, Santa Clara, CA (US)

(72) Inventors: Xin Dong, San Jose, CA (US); Yonggan Fu, Santa Clara, CA (US); Shizhe Diao, Milpitas, CA (US); Wonmin Byeon, Santa Cruz, CA (US); Zijia Chen, Sunnyvale, CA (US); Ameya Sunil Mahabaleshwarkar, Sunnyvale, CA (US); Shih-Yang Liu, Santa Clara, CA (US); Matthijs Van Keirsbilck, Berlin (DE); Min-Hung Chen, Zhubei City (TW); Yoshi Suhara, Los Altos, CA (US); Yingyan Lin, Dunwoody, GA (US); Jan Kautz, Lexington, MA (US); Pavlo Molchanov, Mountain View, CA (US)

(21) Appl. No.: 19/281,064

(22) Filed: Jul. 25, 2025

Related U.S. Application Data
(60) Provisional application No. 63/724,137, filed on Nov. 22, 2024.

(51) Int. Cl. G06F 40/40; G06F 18/25

(52) U.S. Cl. CPC G06F 40/40; G06F 18/251

(57) ABSTRACT

The hybrid-head architecture model can be used to train a language model (LM). It uses a combination of attention heads and state space models (SSMs) to improve the speed and efficiency of inferencing a received input sequence. This disclosure combines the high-resolution recall capabilities of attention heads with the efficient context summarization of SSM heads. The model can be separated into a set of layers, and the input sequence can be processed layer by layer. Each layer can have its own number of attention heads and SSM heads. Fine-tuning and optimization can be applied to each layer, as well as normalization and scaling. To further optimize the performance of the hybrid-head architecture model, learnable meta tokens can be used, which act as a learned cache for attention and SSM heads, enhancing the model's focus on salient information. The attention heads and the SSMs can be processed in parallel.

### CROSS-REFERENCE

This application claims the benefit of U.S. Provisional Application Ser. No. 63/724,137, filed by Xin Dong, et al., on Nov. 22, 2024, entitled “HYBRID-HEAD ARCHITECTURE FOR LANGUAGE MODELS,” commonly assigned with this application and incorporated herein by reference in its entirety.

### TECHNICAL FIELD

This application is directed, in general, to language models and, more specifically, to combining architectures of language models.

### BACKGROUND

Language models (LMs) are a type of machine learning model that is trained to generate words based on the context of given text. Language models are used for various functions, such as auto-suggestions when typing, content generation, document summarization, and conversational artificial intelligence (AI). Large language models (LLMs) are a type of language model that have been trained on large amounts of data and use deep learning to identify complex data patterns. As suggested by the name, small language models (SLMs) are smaller in scale than LLMs and are often trained on specific datasets. Language models, whether LLM or SLM, can use different architectures.

An attention-based architecture used by Transformers has become popular for LMs due to its impressive language modeling capabilities of efficient parallelization and robust long-term recall enabled by token-level key-value (KV) caches. The memory requirements for storing the KV caches and the quadratic computation cost of Transformers can create significant efficiency challenges.

More efficient alternatives, such as parallel, state space models (SSMs) have emerged that offer constant computational and memory complexity during inference and training with hardware-aware optimizations. Despite the advantages, SSMs can still fall short in memory recall tasks compared to Transformers, which impacts the performance of SSMs on general benchmarks and recall-intensive tasks.

### SUMMARY

In one aspect, a hybrid-head model for a language model is disclosed. In one embodiment, the hybrid-head model includes (1) a parallel processing head having one or more state space model (SSM) heads and one or more attention heads, wherein the one or more SSM heads and the one or more attention heads are configured to generate output vectors in parallel by processing an input sequence, and (2) an output combiner configured to generate an output projection for the hybrid-head model by fusing, using an algorithmic combination, the output vectors of the one or more SSM heads and the one or more attention heads.

In a second aspect, a system is disclosed. In one embodiment, the system includes (1) a receiver, configured to receive an input sequence and input parameters, wherein the input sequence includes at least input tokens representing input text, (2) one or more processors, configured to execute code representing a hybrid-head model, wherein the input sequence and the input parameters are used to generate a first set of output vectors from one or more state space model (SSM) heads and a second set of output vectors from one or more attention heads, where at least two of the one or more SSM heads and the one or more attention heads are processed in parallel, and (3) an output combiner configured to apply an algorithm to fuse the first set of output vectors and the second set of output vectors to generate an output projection.

In a third aspect, a method is disclosed. In one embodiment, the method includes (1) receiving an input sequence and input parameters, (2) allocating zero or more attention heads to each layer in a set of layers of the input sequence, (3) allocating zero or more state space model (SSM) heads to each layer in the set of layers, wherein each layer is allocated at least one attention head or one SSM head, (4) processing the input sequence layer by layer, (5) generating a set of attention head output vectors from the zero or more attention heads allocated to each respective layer and a set of SSM head output vectors from the zero or more attention heads allocated to each respective layer, and (6) generating an output projection by combining the set of attention head output vectors and the set of SSM head output vectors.

### BRIEF DESCRIPTION

Reference is now made to the following descriptions taken in conjunction with the accompanying drawings, in which:

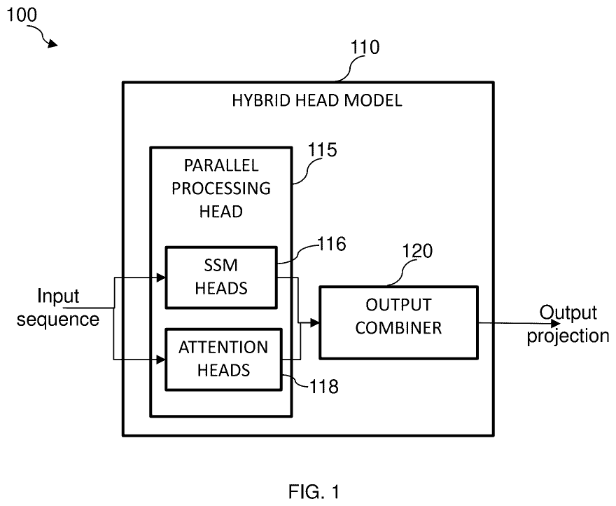

FIG. 1 is an illustration of a diagram of an example hybrid-head architecture constructed according to the principles of the disclosure;

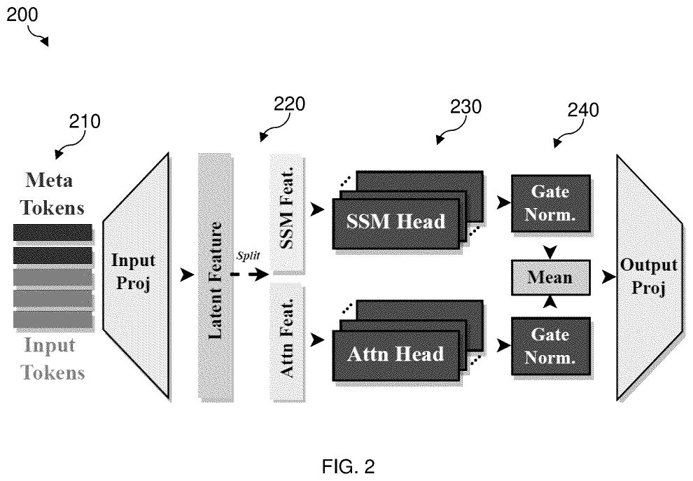

FIG. 2 is an illustration of a diagram of an example hybrid-head model;

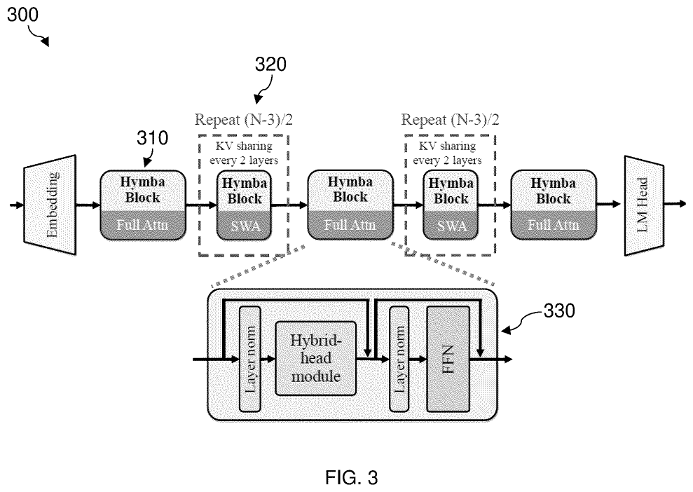

FIG. 3 is an illustration of a diagram of an example LM using the hybrid-head architecture model;

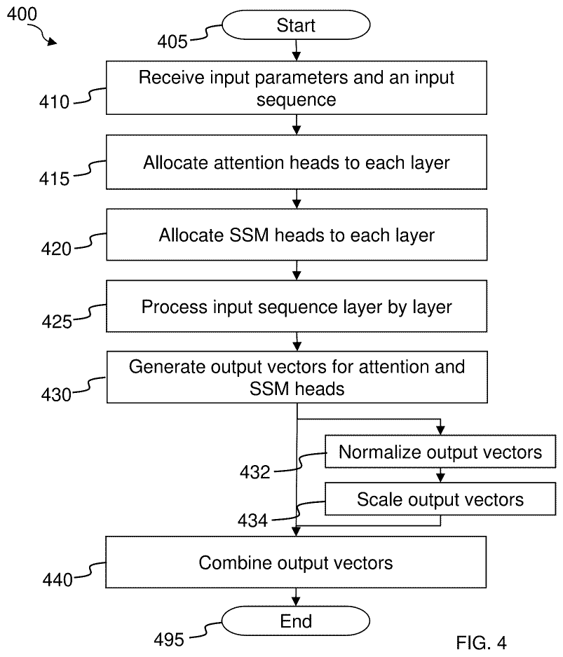

FIG. 4 is an illustration of a flow diagram of an example method to implement a hybrid-head architecture model;

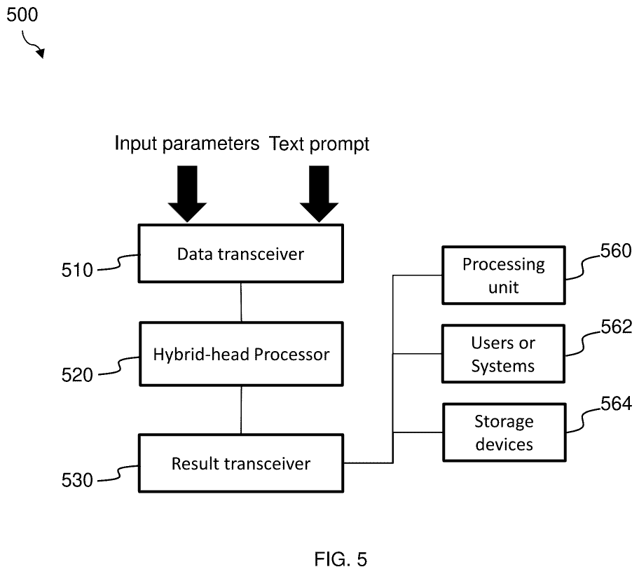

FIG. 5 is an illustration of a block diagram of an example hybrid-head architecture model system; and

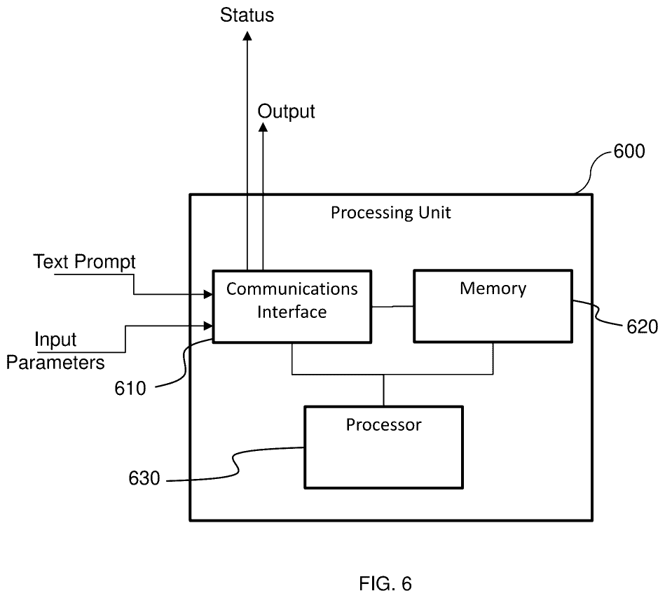

FIG. 6 is an illustration of a block diagram of an example of a hybrid-head architecture model controller according to the principles of the disclosure.

### DETAILED DESCRIPTION

Language models (LMs) are being used to process input text and output context-aware responses to the input text. Large language models (LLMs) process a significant amount of data to generate large models. The cost in memory and storage of the key-value (KV) tokens can make LLM accessibility under some hardware configurations difficult, such as small form factor computing systems (for example, a smartphone). Small language models (SLMs) show promise to fill in the gap left by the LLMS while current SLMs have architectures that may not be efficient in some scenarios. State space models (SSMs) can offer constant complexity and efficient hardware optimization but can struggle with memory recall tasks, thereby affecting their performance. Hybrid architecture models have been introduced to try to reduce the efficiency gaps of the existing LMs.

Some hybrid architecture models have been used that combine attention and SSM layers by sequentially interleaving these layers to capitalize on their respective strengths. These interleaving hybrid models can result in information bottlenecks when a layer type poorly suited for a specific task cannot effectively process the information, which can result in compensation from subsequent layers. An additional problem can be due to initial tokens that often receive significant attention scores from subsequent tokens, even when the initial tokens are not semantically important.

The disclosure recognizes that drawing excessive attention to semantically unimportant tokens does not benefit attention mechanisms. Thus, guiding the attention to focus more on tokens that meaningfully contribute to task performance would be beneficial. Accordingly, the disclosure provides an improved LM architecture model that integrates attention heads and SSM heads within the same layer, providing parallel and complementary processing of the same inputs. The disclosed hybrid-head architecture model (also referred to as hybrid-head model) allows each layer to simultaneously harness a high-resolution recall of attention and efficient contract summarization of SSMs. Thus, the hybrid-head model (also referred to as Hymba) can increase a model's flexibility and expressiveness in handling various types of information flows and memory access patterns when compared to other SSMs or SLMs.

The disclosure introduces meta tokens to enhance the performance of the hybrid-head model. These meta tokens can act as a compressed representation of world knowledge. The meta tokens are prepended to input tokens of input sequences and interact with subsequent input tokens, such as with subsequent input tokens. The meta tokens act as learnable cache initialization that enhances capabilities of SSM heads by providing a dynamic initial state that evolves with the model, and mitigates the issue with LM processors where model attention heads cannot attend to nothing. The meta tokens, therefore, can provide improved performance across general and recall-intensive tasks.

In some aspects, sharing a KV cache between attention heads can be used. Consecutive layers can have a high correlation in the KV cache, the KV cache can be shared between layers as well. For many layers, a sliding window attention algorithm can be used to minimize cache costs. Comprehensive evaluations and ablation studies demonstrate that the hybrid-head model can achieve improved efficiency compared to transformers and previous hybrid models. For example, in commonsense reasoning tasks, the hybrid-head model can outperform Llama with 1.32% higher average accuracy, while using a 11.67× smaller cache size and being measured at 3.49× faster.

To optimize the hybrid-head model for on-device tasks, supervised fine-tuning and direct preference optimization can be used. Parameter-efficient fine-tuning shows the hybrid-head model's strong potential when compared to conventional models. For instance, a DoRA fine-tuned version of the hybrid-head model can outperform the Llama model by 2.4% on the RoleBench benchmark tool.

SSMs, such as Mamba, were introduced to address the quadratic complexity and large inference-time KV cache issues of transformers. Due to their low-resolution memory, SSMs can struggle with memory recall and performance. To overcome these limitations, this disclosure presents a roadmap for developing efficient and high-performing SLMs. The roadmap can comprise (1) Fusing attention and SSM heads in parallel within a hybrid-head model which can outperform sequential stacking, e.g., parallel processing heads. Heads can process the same information simultaneously, leading to improved reasoning and recall accuracy. Sequential fusion can lack synergy, as the blocks operate on each set of inputs independently.

(2) While attention heads can improve task performance, they can increase KV cache requirements and reduce throughput. To mitigate this, the hybrid-head model can be optimized by combining local and global attention head output vectors and employing cross-layer KV cache sharing. This can improve throughput, for example, in testing by 3× and can reduce cache size by almost 4×.

(3) A set of learnable embeddings prepended to inputs, functioning as learned cache initialization can be used to enhance focus on relevant information. These tokens can serve a dual purpose: (i) they can mitigate attention drain by acting as backstop tokens, redistributing attention effectively, and (ii) they can encapsulate compressed world knowledge. For example, a set of 128 learnable embeddings can be used, or other numbers of learnable embeddings.

(4) The roadmap can be scaled to larger data sets than conventional approaches. In testing the disclosure, for example, on a 300 million parameter model using 100 billion training tokens, the final models were trained with 1.5 trillion tokens and scaled up to models with 350 million parameters and 1.5 billion parameters.

SSM models can be efficient while suffering from limited recall capabilities and task performance. Given the high recall resolution of attention, the disclosed processes aim to (1) combine the processing efficiency and context summarization capabilities of SSMs with the high recall resolution of attention, and (2) develop a fused building block to achieve this goal, so it can serve as a fundamental component for constructing future foundation models. Previous hybrid models often combined attention heads and SSMs in a sequential manner. This strategy may lead to information bottlenecks when a type of layer that is poorly suited for a specific task cannot effectively process the information.

The advantage of fusing attention and SSMs in parallel into a hybrid-head model can be that different attention and SSM heads can store, retrieve, and process the same piece of information in distinct ways, thereby inheriting the strengths of the operators. The fusing can utilize various types of algorithmic combinations. The hybrid-head model can be represented by a unified and symmetric formulation. Given the input sequence \tilde{X}, which is the original input sequence X prepended with meta tokens, the input projection Win proj=[W^{Q}, W^{K}, W^{V}, W^{SSM}, W^{G}] projects \tilde{X} to the query, key, and value of the attention heads using W^{Q}, W^{K}, and W^{V}, respectively, as well as the input features and gates of the SSM heads using W^{SSM} and W^{G}, respectively.

The output of attention heads Yₐₜₜₙ can be formulated as: Yₐₜₜₙ=softmax(QK^{T})W^{V}\tilde{X}=Mₐₜₜₙ\tilde{X} where Mₐₜₜₙ=softmax(QK^{T})W^{V} and Q=W^{Q}\tilde{X}, K=W^{K}\tilde{X}. Similar to the attention heads, the SSM heads in our model can be represented using a data-controlled linear operator Mₛₛₘ. The SSM head output Yₛₛₘ can be formulated as:

$${α}^{i , j} = {C}_{i} ( {\prod }_{k = j + 1}^{i} exp ( A {Δ}_{k} ) ) {B}_{j} {Δ}_{j}$$

and Yₛₛₘ=G⊙α(A, B, C, Δ) W^{SSM} \tilde{X}=Mₛₛₘ\tilde{X} where Mₛₛₘ=G⊙α(A, B, C, Δ) W^{SSM}, G=W^{G}\tilde{X} is an output gate, and A, B, C, Δ are the SSM parameters. A is a learnable matrix, B=W_{B}Xₛₛₘ, C=W_{C}Xₛₛₘ, and Δ=Softplus (W_{Δ}Xₛₛₘ) with Xₛₛₘ=W^{SSM}\tilde{X}.

The output magnitudes of the SSM heads, Yₛₛₘ, are consistently larger than those of the attention heads, Yₐₜₜₙ. In some aspects, to ensure effective fusion, the SSM heads and the attention heads can be normalized. In some aspects, the SSM heads and the attention heads can be re-scaled. In aspects where normalization occurs or rescaling occurs, learnable vectors can be used to improve training stability. The output vectors from each operation can be arithmetically combined (e.g., fusing), such as using an average, followed by a final output projection. The overall formulation of the fused model can be represented symmetrically as Y=Wₒᵤₜ_{ₚᵣₒⱼ}(β₁norm(Mₐₜₜₙ\tilde{X})+β₂norm(Mₛₛₘ\tilde{X})) where β₁ and β₂ are learnable vectors that re-scale each channel of the outputs from the attention and SSM heads, respectively. In some aspects, the ratio of SSMs and attention heads in the hybrid-head model can be changed to improve the efficiency of the model.

The components in the hybrid-head model can be interpreted as analogous to human brain functions. The attention heads can provide high recall resolution and thus act like snapshot memories in the human brain, storing detailed recollections of a moment or event. In contrast, the SSM heads can summarize the context through a constant cache and thus function as fading memories, which gradually forget the details of past events while retaining their core or gist. The hybrid-head model demonstrates that the summarized global context from fading memories enables allocating more snapshot memories for memorizing local information while maintaining recall capabilities. This is achieved by replacing global attention with local attention, thus improving memory efficiency.

The relative importance of attention and SSM heads in each layer can be realized by setting β₁ or β₂ 0 and recording the final accuracy. The relative importance of attention or SSM heads in the same layer can be input-adaptive and can vary across tasks, suggesting that they can serve different roles when handling various inputs. The SSM head in the first layer can be important for language modeling, and removing this SSM head can cause a drop in accuracy to random-guess levels. Removing one attention or SSM head can result in an average accuracy drop, for example, of 0.24% to 1.1%.

The hybrid-head model can improve recall and reasoning capabilities while compromising memory and throughput efficiency due to the KV cache used by the attention heads. To address this, the KV cache can be reduced while maintaining comparable task performance. Local attention algorithms, such as the sliding window attention (SWA) algorithm, can offer a more efficient alternative to global full attention algorithms, though local attention algorithms risk losing global context. With the presence of SSM heads in the hybrid-head model, which already summarizes global context, global full attention can be replaced with local attention, achieving a better balance between efficiency and performance.

The ratio of local attention and global attention heads can be adjusted to improve efficiency. Replacing global attention heads can result in a drop in accuracy, for example, over 20.0% on recall-intensive tasks. Using global attention in three layers can be sufficient to recover recall-intensive accuracy while maintaining comparable commonsense reasoning accuracy. In some aspects, the global attention heads can be maintained in the first, middle, and last layers. For example, this strategy can achieve improvements of 2.7× to throughput and 3.8× to cache reduction.

KV cache can share a high similarity between adjacent layers, suggesting that using separate KV caches for each layer can lead to cache and parameter redundancy. A cross-layer KV sharing process can be employed, where keys and values are shared between consecutive layers. In some aspects, every two layers can share the same KV cache. In other aspects, other layer combinations can be used. This strategy can reduce KV memory usage and model parameters, allowing the saved parameters to be reallocated to other model components. For example, cross-layer KV sharing can improve throughput by 1.15× while maintaining comparable recall accuracy and boosting common sense accuracy by +0.60%.

The initial tokens, though not semantically important, can receive attention scores from subsequent tokens. The attention heads can be guided to focus more on tokens that meaningfully contribute to task performance. In some aspects, a set of learnable meta tokens can be used, such as R=[r₁, r₂, . . . , rₘ], to serve as the initial tokens. Given the input sequence X=[x₁, x₂, . . . , xₙ], these meta tokens can be prepended to the input sequence, forming the modified input sequence \tilde{X}=[R, X]=[r₁, r₂, . . . , rₘ, x₁, x₂, . . . , xₙ] where \tilde{X} represents the new input sequence for the model. At inference time, since the meta tokens are fixed and appear at the beginning of any input sequences, their computation can be performed offline. Thus, the role of meta tokens at inference can be viewed as learned cache initialization to modulate the subsequent tokens, allowing subsequent tokens to focus more on those that contribute meaningfully to task performance.

The meta tokens can participate in the attention and SSM calculations of subsequent tokens, analogous to metamemory in the human brain, which helps recognize where to locate needed information in other memories. When the prompts are from different domains (e.g., article, math, and code), different meta tokens can be activated. This suggests that different meta tokens encapsulate different world knowledge, which can be leveraged to guide the attention mechanism to focus on relevant information.

Meta tokens can perform the following functions. (1) Prevent token overwriting. Attention heads tend to overwrite and over-attend to some tokens, acting as a garbage collector (e.g., attention sinks). Adding learnable tokens allows for more representative feature maps. Therefore, the model should be provided with tokens that are independent of the input.

(2) Exit tokens. Prepending tokens to the input affects the shape of the analysis function by modifying the denominator. The denominator can be modified, such as by adding one, allowing the attention to output zeros. In other aspects, other values or algorithms can be used to modify the analysis function. Adding one can be equivalent to prepending an all-zero token to the keys and values. This modification can help resolve the forced to attend situation for some attention heads. In some aspects, meta tokens can be learnable, allowing them to learn an optimal analysis function shape.

(3) Initialization. Learning initial tokens can be seen as a form of prompt tuning or learned initialization for KV cache and SSM state tokens. For inference, meta tokens are fixed, and the keys and values can be precomputed offline and stored. Task-specific meta tokens can be used.

Meta tokens can boost recall capabilities and commonsense reasoning accuracy. To analyze the impact of meta tokens on the attention mechanism, the entropy of the attention map for the attention and SSM heads before and after introducing meta tokens can be analyzed. The attention map entropy can reflect the distribution of attention scores across tokens, where lower entropy indicates stronger retrieval effects, as the attention scores are concentrated around a small subset of tokens, and vice versa for higher entropy. After introducing meta tokens, the attention and SSM heads can exhibit a reduction in entropy. Combined with the improved reasoning and recall capabilities, the meta tokens can help the attention and SSM heads focus more on a subset of important tokens that contribute most to task performance.

The hybrid-head model's attention pattern can be viewed as a combination of individual components from sliding window attention, meta tokens, and SSM. Elements can be categorized in the attention map into four types: (1) Meta: can be attention scores from real tokens to meta tokens. This category can reflect the model's preference for attending to meta tokens. In some aspects, in the attention map, they can be located in the first few columns if a model has meta tokens. (2) BOS: can be attention scores from real tokens to the beginning-of-sequence token. In the attention map, they can be located in the first column, right after the meta tokens. (3) Self: can be attention scores from real tokens to themselves. In the attention map, they can be located in the diagonal line. (4) Cross: can be attention scores from real tokens to other real tokens. In the attention map, they can be located in the off-diagonal area.

In analyzing the attention maps, the attention scores can be algorithmically combined, such as summing, from different categories. In some aspects, the summed scores can be normalized by the context length. In some aspects, SSM heads can calculate their attention maps and normalize the attention maps to ensure each row sums to one. In conventional models, attention scores can be more concentrated on the ‘BOS’ category. Conventional models can have a higher proportion of ‘Self’ category attention scores. In the disclosed hybrid-head model, meta tokens, attention heads, and SSM heads work complimentary to each other, leading to a more balanced distribution of attention scores across different categories of tokens. Meta tokens can offload the attention scores from ‘BOS’, allowing the model to focus more on the real tokens. SSM heads summarize the global context, which focus more on current tokens (e.g., ‘Self’ attention scores). On the other hand, attention heads pay less attention to ‘Self’ and ‘BOS’ tokens and more attention to other tokens (e.g., ‘Cross’ attention scores). This suggests that the hybrid-head design of the hybrid-head model can effectively balance the attention distribution across different types of tokens, potentially leading to better performance.

Turning now to the figures, FIG. 1 is an illustration of a diagram of an example hybrid-head architecture 100 constructed according to the principles of the disclosure. Hybrid-head architecture 100 can be used as an architecture model for the hybrid-head model as described herein. Hybrid-head architecture 100 can have a hybrid-head model 110 that can contain the disclosed processes. Hybrid-head model 110 includes a parallel processing system 115 and an output combiner 120. There can be more than one hybrid-head model in an LM system. Parallel processing system 115, e.g., a parallel processing head, can receive an input sequence, for example, a text input or text prompt. Parallel processing system 115 has at least one head, wherein the at least one head is one or more SSM heads 116, one or more attention heads 118, or a combination thereof. These heads can generate output vectors after analyzing an allocated portion of the input sequence.

Output combiner 120 is configured to combine the output vectors from SSM heads 116 and attention heads 118, such as being fused using a selected algorithm. The algorithm used can be specified in input parameters. The combined output can be communicated as an output projection. The output projection can be communicated to a user or to another system, such as to be used as input for further processing.

FIG. 2 is an illustration of a diagram of an example hybrid-head model 200. Hybrid-head model 200 demonstrates a functional view perspective of the disclosed processes. Hybrid-head model 200 can be used for training LM models and for inferencing new input sequences using the trained LM.

Hybrid-head model 200 receives an input sequence 210. Input sequence 210 can be represented by a set of input tokens or can be separated into a set of input tokens. The input projection is the conventional process of transforming the input embeddings of the input sequence into vector spaces, where each vector space is associated with a specific type of head. The embeddings attempt to capture the meaning of each respective token in the input sequence. At functional area 220, the model is separated into a set of layers, and the input sequence is processed layer by layer. There can be one or more layers in the set. For each layer in the set of layers, zero or more SSM heads and zero or more attention heads can be allocated to each layer. There needs to be at least one head type assigned to each layer. The various head types do not need to be allocated evenly. Uneven or unbalanced splits of the input sequence can be used. For example, the first, middle, and last layers can have at least one SSM head, while the other layers can have at least one attention head. Other combinations are possible as well.

In a functional area 230, the SSM heads and attention heads can process in parallel, near parallel, serially, or in other combinations. Each head in each layer can generate an output vector using the respective head analysis. In a functional area 240, the output vectors can be combined to generate an output projection, such as using an output combiner. The output projection is a conventional process to combine the outputs from multiple heads and transform the output into a unified vector representation. In some aspects, the output is transformed into the original embedding space or an output dimension. The combination can be an algorithm to use can be specified by input parameters. The output projection can be trained using an unsupervised pretraining algorithm, a supervised fine-tuning algorithm, or a direct preference optimization algorithm.

FIG. 3 is an illustration of a diagram of an example LM 300 using the hybrid-head architecture model. LM 300 is a demonstration of one potential implementation of the hybrid-head architecture model. LM 300 can have various quantities of a first type of inference blocks, such as an inference block 310, that uses full attention head analysis, e.g., uses global attention. LM 300 can have various quantities of a second type of inference blocks, such as an inference block 320.

In each of the inference blocks having “Full Attn” can utilize attention heads processing the input sequence at full attention, e.g., global attention. In each of the inference blocks having “SWA” can utilize attention heads processing the input sequence with shared attention, e.g., local attention. In some aspects, inference block 320 can include a KV cache for implementing KV cache sharing, for example, for sharing every two consecutive layers. Inference block 310 and inference block 320 can be represented by a detailed block view 330. Detail block view 330 corresponds to hybrid-head model 200 of FIG. 2.

The number of inference block 310 and inference block 320 can be determined by a specified value, N. N, which can vary, represents the total number of blocks for the architecture. For example, N can be 32. When (N−3)/2 results in an uneven number, one additional inference block can be located either before or after the middle inference full attention block. In some aspects, the architecture can include at least three full attention inference blocks, with the SWA inference blocks located between them, as demonstrated in LM 300. LM 300 can be implemented on one or more computing devices having one or more processors (such as GPUs) and one or more memories for storing operating instructions, corresponding to one or more algorithms, that direct the operation of the one or more processors.

FIG. 4 is an illustration of a flow diagram of an example method 400 to implement a hybrid-head architecture model. Method 400 can be performed on a computing system, for example, hybrid-head architecture model system 500 of FIG. 5 or hybrid-head architecture model controller 600 of FIG. 6. The computing system can be one or more processors in various combinations (e.g., CPUs, GPUs, SIMDs, or other types of processors), a data center, a cloud environment, a server, a laptop, a mobile device, a smartphone, a PDA, or other computing system capable of receiving the thread requests, and capable of executing threads in parallel. Method 400 can be encapsulated in software code or hardware, for example, an application, code library, code module, dynamic link library, module, function, RAM, ROM module, and other software and hardware implementations. The software can be stored in a file, database, or other computing system storage mechanism. Method 400 can be partially implemented in software and partially in hardware. Method 400 can perform the steps for the described processes, for example, training the LM using the hybrid-head model, or to inference an input sequence to generate an output projection of the input sequence.

Method 400 starts at a step 405 and proceeds to a step 410. In step 410 input parameters and an input sequence can be received. The input parameters can include a specified algorithm to use for the combining step. The input parameters can specify whether to use a normalization algorithm and the type of algorithm. The input parameters can specify whether to use a scaling algorithm and the type of algorithm. The input parameters can specify whether to use a learnable vector for rescaling the output vectors. The input parameters can specify whether to use meta tokens and how they are prepended to the input sequence. The input parameters can specify whether to use KV cache sharing and what combinations of layers can share the cache, for example, every two or three consecutive layers can share a cache. The input parameters can specify the type of attention to use for the various heads in the various layers, for example, some attention heads can be specified as using global attention, and other attention heads can be specified as using sliding window attention. The input parameters can specify the size of the sliding window attention. The input parameters can specify whether to use a fine-tuning algorithm or to use a direct preference optimization.

In a step 415, attention heads are allocated to each layer. There can be zero or more attention heads for each layer. The global versus local attention can be set for each attention head. In a step 420, SSM heads can be allocated to each layer. There can be zero or more SSM heads for each layer. For example, in some aspects, the first, middle, and last layers can have SSM heads, while the other layers do not have SSM heads. In some aspects, the one or more SSM heads and the one or more attention heads are organized in layers within the parallel processing head, and heads in the parallel processing head allocated to a first layer, a middle layer, and a last layer utilize a global attention algorithm, and other heads in the parallel processing head utilize a local attention algorithm.

In a step 425, the model can be separated into a set of layers, and the input sequence is processed layer by layer. There is a minimum of one input sequence in one layer in the set. Additional layers can be included, if appropriate for the input sequence. The input can be processed layer by layer.

In a step 430, each attention head and SSM head can generate an output vector. This work can be processed in parallel, partially in parallel, overlapping, serially, or in various combinations thereof. In some aspects, in a step 432, the output vectors can be normalized. In some aspects, in a step 434, the output vectors can be scaled. Proceeding to a step 440, the output vectors from each head can be combined, e.g., fused, to generate an output projection for the input sequence. Various algorithms can be used to perform the combination. Method 400 ends at a step 495.

FIG. 5 is an illustration of a block diagram of an example hybrid-head architecture model system 500. Hybrid-head architecture model system 500 can be implemented in one or more computing systems or one or more processors. In some aspects, hybrid-head architecture model system 500 can be implemented using a hybrid-head architecture model controller such as hybrid-head architecture model controller 600 of FIG. 6. Hybrid-head architecture model system 500 can implement one or more aspects of this disclosure, such as method 400 of FIG. 4.

Hybrid-head architecture model system 500, or a portion thereof, can be implemented as an application, a code library, a dynamic link library, a function, a module, a header file, other software implementations, or combinations thereof. In some aspects, hybrid-head architecture model system 500 can be implemented in hardware, such as a ROM, a graphics processing unit, or other hardware implementations. In some aspects, hybrid-head architecture model system 500 can be implemented partially as a software application and partially as a hardware implementation. Hybrid-head architecture model system 500 is a functional view of the disclosed processes, and an implementation can combine or separate the functions in one or more software or hardware systems.

Hybrid-head architecture model system 500 includes a data transceiver 510, a hybrid-head processor 520, and a result transceiver 530. The output, e.g., the output projection, can be communicated to a data receiver, such as one or more of a processing system 560 (one or more combinations of processors, processing cores, one or more users or systems 562, or one or more storage devices 564. The output can be used to store the output projection for use by other systems, for example, other LM systems for further processing or analysis. The output projection can be trained using an unsupervised pretraining algorithm, a supervised fine-tuning algorithm, or a direct preference optimization algorithm.

In some aspects, the hybrid-head model can be used to train the language model and the meta tokens are randomly initialized at a beginning of the training. In some aspects, the meta tokens can be updated during the training via a gradient signal.

In some aspects, the results of hybrid-head processor 520, such as those communicated to one or more processing systems 560, one or more storage devices 564, or one or more users or systems 562, can be used as input into another process or system, such as a machine learning system. The output projection can be used for further processing, such as for input into robotic teaching, for validation of other system processes, or real-world applications, such as industrial or domestic uses, for example, to be used by a robotic system to perform a task as directed by the output projection. The output projection can be trained using an unsupervised pretraining algorithm, a supervised fine-tuning algorithm, or a direct preference optimization algorithm.

Data transceiver 510 can receive the input parameters. The input parameters can be algorithms to use, such as the combination (e.g., fusion algorithm) to implement, whether to implement normalization or scaling, and other operational parameters. In some aspects, data transceiver 510 can be part of hybrid-head processor 520.

Result transceiver 530 (e.g., a transmitter) can communicate one or more outputs to one or more data receivers, such as processing systems 560, one or more users or systems 562, storage devices 564, or other related systems, whether proximate result transceiver 530 or distant from result transceiver 530. Data transceiver 510, hybrid-head processor 520, and result transceiver 530 can be, or can include, conventional interfaces configured for transmitting and receiving data. Data transceiver 510, hybrid-head processor 520, or result transceiver 530 can be implemented as software components, for example, a virtual processor environment, as hardware, for example, circuits of an integrated circuit, or combinations of software and hardware components and functionality. The functionality described for these components remains intact regardless of how the functionality is implemented.

Hybrid-head processor 520 (e.g., one or more processors such as processor 630 of FIG. 6) can implement the analysis and algorithms as described herein, utilizing the input parameters. Hybrid-head processor 520 can be one or more of a multicore processor, a multiprocessor system, or a streaming multiprocessor. Hybrid-head processor 520 can be implemented by a central processor unit (CPU), a graphics processor unit (GPU), or other types of processors. In some aspects, hybrid-head processor 520 can be a non-transitory computer program product having a series of operating instructions stored on a non-transitory computer-readable medium that directs a processing apparatus, when executed thereby to perform operations as disclosed herein. In some aspects, hybrid-head processor 520 can be a non-transitory computer-readable medium having a series of operating instructions that directs a processing apparatus, when executed thereby to perform operations as disclosed herein. In some aspects, hybrid-head processor 520 can perform the functions of an output combiner to generate the output projection by fusing, e.g., algorithmically combining, the output vectors from the various SSM and attention heads.

A memory or data storage system of hybrid-head processor 520 (such as a core cache, L1 cache, L2 cache, or other memory systems) can be configured to store the processes and algorithms for directing the operation of hybrid-head processor 520. Hybrid-head processor 520 can include a processor that can be configured to operate according to the analysis operations and algorithms disclosed herein, and an interface to communicate (transmit and receive) data.

FIG. 6 is an illustration of a block diagram of an example of a hybrid-head architecture model controller 600 according to the principles of the disclosure. Hybrid-head architecture model controller 600 can be stored on one computer or multiple computers. The various components of hybrid-head architecture model controller 600 can communicate via wireless or wired conventional connections. A portion or a whole of hybrid-head architecture model controller 600 can be located at one or more locations. In some aspects, hybrid-head architecture model controller 600 can be part of another system (e.g., processor, core, server, or other systems), and can be integrated with one device, such as a part of a processing system. Hybrid-head architecture model controller 600 represents a demonstration of the functionality employed for the disclosure, and implementations can use a variety of devices, for example, circuits of a processor, dedicated processors, virtual systems, servers, other computing or processing systems, be in software or hardware, or various combinations thereof.

Hybrid-head architecture model controller 600 can be configured to perform the various functions disclosed herein, including receiving input parameters and input sequence, and generating results (e.g., output projections, statuses) from the execution of the methods and processes described herein, such as training the LM or inferencing a new input sequence. Hybrid-head architecture model controller 600 includes a communications interface 610, a memory 620, and a processor 630.

Communications interface 610 can be configured to transmit and receive data. For example, communications interface 610 can receive the input parameters. Communications interface 610 can transmit the output or interim outputs. In some aspects, communications interface 610 can transmit a status, such as a success or failure indicator of hybrid-head architecture model controller 600 regarding receiving the various inputs, transmitting the generated outputs, or producing the results.

In some aspects, processor 630 can perform the operations as described by hybrid-head processor 520. Communications interface 610 can communicate via communication systems used in the industry. For example, wireless or wired protocols can be used. Communication interface 610 can perform the operations as described for data transceiver 510 and result transceiver 530 of FIG. 5.

Memory 620 can be configured to store a series of operating instructions that direct the operation of processor 630 when initiated, including supporting code representing the algorithm for training an LM using the hybrid-head model and using the LM for inferencing input sequences. Memory 620 can be a non-transitory computer-readable medium. Multiple types of memory can be used for the data storage systems, and memory 620 can be distributed.

Processor 630 can be one or more processors. Processor 630 can be a combination of processor types, such as a CPU, a GPU, a single instruction multiple data (SIMD) processor, or other processor types. Processor 630 can be configured to produce the output, one or more interim outputs, and statuses utilizing the received inputs. Processor 630 can determine the output using parallel processing. Processor 630 can be an integrated circuit. In some aspects, processor 630, communications interface 610, memory 620, or various combinations thereof, can be an integrated circuit. Processor 630 can be configured to direct the operation of hybrid-head architecture model controller 600. Processor 630 includes the logic to communicate with communications interface 610 and memory 620, and perform the functions described herein. Processor 630 can be capable of performing or directing the operations as described by hybrid-head processor 520 of FIG. 5.

For example, in some aspects, hybrid-head architecture model system 500 or hybrid-head architecture model controller 600 can perform training an LM using the hybrid-head model and can perform inferencing on a received input sequence. In some aspects, hybrid-head architecture model system 500 or hybrid-head architecture model controller 600 can be part of another system that receives the input parameters. For example, in some aspects, hybrid-head architecture model system 500 or hybrid-head architecture model controller 600 can be part of a machine learning system, an AI generative tool, or can be in a data center, a cloud system, an edge system, a corporate system, or other type of system or location. In some aspects, for training, the input sequence can be received from a data store. In some aspects, hybrid-head architecture model system 500 or hybrid-head architecture model controller 600 can be part of a machine learning system, where hybrid-head processor 520 can be part of the machine learning processes. In some aspects, hybrid-head architecture model system 500 or hybrid-head architecture model controller 600 can implement a non-transitory computer program product having a series of operating instructions stored on a non-transitory computer-readable medium that directs a data processing apparatus when executed thereby to perform operations, the operations comprising the steps described herein for this disclosure, such as method 400 of FIG. 4.

A portion of the above-described apparatus, systems, or methods can be embodied in or performed by various digital data processors or computers, wherein the computers are programmed or store executable programs of sequences of software instructions to perform one or more of the steps of the methods. The software instructions of such programs can represent algorithms and be encoded in machine-executable form on non-transitory digital data storage media, e.g., magnetic or optical disks, random-access memory (RAM), magnetic hard disks, flash memories, or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs can be included on a graphics card that includes one or more memory devices and is configured to interface with the motherboard of a computer. The GPUs can be integrated GPUs (iGPUs) that are co-located with a CPU on one chip. Configured or configured to means, for example, designed, constructed, or programmed, with the necessary logic or features for performing a task or tasks. The processors or computers can be part of GPU racks located in a data center. The GPU racks can be high-density (HD) GPU racks that include high-performance GPU compute nodes and storage nodes. The high performance GPU compute nodes can be servers designed for general-purpose computing on graphics processing units (GPGPU) to accelerate deep learning applications. For example, the GPU compute nodes can be servers of the DGX product line from NVIDIA Corporation of Santa Clara, California.

The compute density provided by the HD GPU racks is advantageous for AI computing and GPU data centers directed to AI computing. The HD GPU racks can be used with reactive machines, autonomous machines, self-aware machines, and self-learning machines that may need a large compute intensive server infrastructure. For example, the GPU data centers employing HD GPU racks can provide the storage and networking needed to support large-scale neural network (NN) training, such as for the NNs disclosed herein used for neural motion planners. The NNs can be Deep Neural Networks (DNN).

The NNs disclosed herein include multiple layers of connected nodes that can be trained with input data to solve complex problems. For example, contextual data, UPC, proposed trajectories, or a combination thereof can be used as input data for training of the NN. Once the NNs are trained, the NNs can be deployed and used to generate planned trajectories.

In one example of training, data flows through the NNs in a forward propagation phase until a prediction is produced that indicates a label corresponding to the input. When the NNs do not correctly label the input, errors between the correct label and the predicted label are analyzed, and the weights are adjusted for features of the layers during a backward propagation phase that correctly labels the inputs in a training dataset. With thousands of processing cores that are optimized for matrix math operations, GPUs such as noted above are capable of delivering the performance needed for training NNs for artificial intelligence and machine learning applications.

Portions of disclosed examples or embodiments can relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic or features for performing a task or tasks. Examples of program code include machine code, such as produced by a compiler, and files containing higher-level code that can be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, utilized, or combined with other elements, components, or steps that are not expressly referenced.

Those skilled in the art to which this application relates will appreciate that other and further additions, deletions, substitutions, and modifications can be made to the described embodiments. It is also to be understood that the terminology used herein is to describe particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein. Additional material is also submitted herewith.

What is claimed is:

1. A hybrid-head model for a language model, comprising:
a parallel processing head having one or more state space model (SSM) heads and one or more attention heads, wherein the one or more SSM heads and the one or more attention heads are configured to generate output vectors in parallel by processing an input sequence; and
an output combiner configured to generate an output projection for the hybrid-head model by fusing, using an algorithmic combination, the output vectors of the one or more SSM heads and the one or more attention heads.

2. The hybrid-head model as recited in claim 1, wherein the output combiner normalizes the output vectors for the one or more SSM heads, and normalizes the output vectors for the one or more attention heads.

3. The hybrid-head model as recited in claim 1, wherein the output combiner rescales the output vectors for the one or more SSM heads, and rescales the output vectors for the one or more attention heads.

4. The hybrid-head model as recited in claim 1, wherein the output combiner averages the output vectors from the one or more SSM heads and the one or more attention heads.

5. The hybrid-head model as recited in claim 1, wherein the hybrid-head model is used to train and the output combiner uses random initialization for at least normalizing and rescaling of the output vectors before starting the training.

6. The hybrid-head model as recited in claim 1, wherein the output combiner uses learnable vectors to rescale the output vectors of the one or more SSM heads or for rescaling the output vectors of the one or more attention heads.

7. The hybrid-head model as recited in claim 1, wherein the input sequence includes input tokens, and meta tokens are prepended to the input tokens in the input sequence.

8. The hybrid-head model as recited in claim 7, wherein the meta tokens are used to redistribute attention to reduce attention drain.

9. The hybrid-head model as recited in claim 7, wherein the meta tokens are used to encapsulate compressed world knowledge.

10. The hybrid-head model as recited in claim 7, wherein the meta tokens are learnable cache initializations for use by the one or more SSM heads.

11. The hybrid-head model as recited in claim 7, wherein the meta tokens are fixed for an inferencing.

12. The hybrid-head model as recited in claim 7, wherein the hybrid-head model is used to train the language model and the meta tokens are randomly initialized at a beginning of the training.

13. The hybrid-head model as recited in claim 12, wherein the meta tokens are updated during the training via a gradient signal.

14. The hybrid-head model as recited in claim 1, further comprising:
a key-value (KV) cache configured to be shared between the one or more attention heads, wherein the KV cache is used to generate the output vectors.

15. The hybrid-head model as recited in claim 14, wherein at least one of the attention heads utilizes a sliding window attention algorithm with the KV cache.

16. The hybrid-head model as recited in claim 14, wherein the KV cache is configured to share keys and values between two consecutive layers.

17. The hybrid-head model as recited in claim 14, wherein the KV cache is further configured to employ cross-layer sharing to combine local attention head output vectors and global attention head output vectors.

18. The hybrid-head model as recited in claim 1, wherein the output projection is trained using an unsupervised pretraining algorithm, a supervised fine-tuning algorithm, or a direct preference optimization algorithm.

19. The hybrid-head model as recited in claim 1, wherein the one or more SSM heads and the one or more attention heads are organized in layers within the parallel processing head, and heads in the parallel processing head allocated to a first layer, a middle layer, and a last layer utilize a global attention algorithm, and other heads in the parallel processing head utilize a local attention algorithm.

20. The hybrid-head model as recited in claim 19, wherein the local attention algorithm utilizes a sliding window attention algorithm of three.

21. A system, comprising:
a receiver, configured to receive an input sequence and input parameters, wherein the input sequence includes at least input tokens representing input text;
one or more processors, configured to execute code representing a hybrid-head model, wherein the input sequence and the input parameters are used to generate a first set of output vectors from one or more state space model (SSM) heads and a second set of output vectors from one or more attention heads, where at least two of the one or more SSM heads and the one or more attention heads are processed in parallel; and
an output combiner configured to apply an algorithm to fuse the first set of output vectors and the second set of output vectors to generate an output projection.

22. The system as recited in claim 21, wherein the one or more processors is a first set of processors, and one or more additional sets of processors are used to process the input sequence, where each set of processors performs respective processing in parallel.

23. The system as recited in claim 21, wherein the one or more processors is one or more of a central processor unit (CPU) or a graphics processor unit (GPU).

24. The system as recited in claim 21, wherein the output projection is received by another system and used as an input, or communicated to a user.

25. A method, comprising:
receiving an input sequence and input parameters;
allocating zero or more attention heads to each layer in a set of layers of the input sequence;
allocating zero or more state space model (SSM) heads to each layer in the set of layers, wherein each layer is allocated at least one attention head or one SSM head;
processing the input sequence layer by layer;
generating a set of attention head output vectors from the zero or more attention heads allocated to each respective layer and a set of SSM head output vectors from the zero or more attention heads allocated to each respective layer; and
generating an output projection by combining the set of attention head output vectors and the set of SSM head output vectors.

26. The method as recited in claim 25, wherein the generating further comprises:
normalizing each attention output vector in the set of attention head output vectors;
normalizing each SSM output vector in the set of SSM head output vectors;
scaling the each attention output vector in the set of attention head output vectors; and
scaling the each SSM output vector in the set of SSM head output vectors.

27. The method as recited in claim 25, wherein the generating further comprises:
sharing a key-value (KV) cache between at least two consecutive layers in the set of layers.

28. The method as recited in claim 25, wherein the zero or more attention heads or the zero or more SSM heads in a first layer, a middle layer, and a last layer in the set of layers utilizes a global attention algorithm and the zero or more attention heads or the zero or more SSM heads in other layers in the set of layers utilizes a sliding window attention algorithm.
